(19) United States
(12) Patent Application Publication
(10) Pub. No.: US 2009/0173854 A1
(43) Pub. Date: Jul. 9, 2009

(54) Adjustable Height Toggle Foot

(75) Inventor: Todd Ryan, Riverside, CA (US)

Correspondence Address: FISH & ASSOCIATES, PC;ROBERT D. FISH, 2603 Main Street, Suite 1000, Irvine, CA, 92614-6232, US

(73) Assignee: DANA INNOVATIONS, San Clemente, CA (US)

(21) Appl. No.: 11/969,435

(22) Filed: Jan. 4, 2008

(51) Int. Cl. E04G 5/06; B23P 19/04

(52) U.S. Cl. 248/222.12; 29/262

(57) ABSTRACT

A clamping system includes a clamp with an optional cap or other extender that adapts the clamp to walls, ceilings or other partitions of different thicknesses. Preferred clamping arms “toggle” out of the way during installation. Kits can include multiple extenders of different sizes. Contemplated systems can be used for installing speakers, lighting fixtures, television monitors, wall switches and myriad other devices.

### FIELD OF THE INVENTION

The field of the invention is mounting system enhancements.

### BACKGROUND

There are numerous systems for mounting speakers, lighting fixtures, television monitors, wall switches and myriad other devices on walls, ceilings, and other partitions. Many of those systems are problematic, however, in that they require an installer to utilize a support beam. Oftentimes, support beams are in the wrong place, or are otherwise not readily accessible. Screwing or nailing the device directly to the partition without a support beam can be satisfactory for lightweight items, but is inadequate for heavier items.

One solution is to clamp the device to the partition itself, since a clamp preserves the strength and integrity of the partition better than a screw or a nail. US 20060194473 to Lange teaches wall clamps, but they cannot effectively clamp walls of different thicknesses. Lange and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

US 20070120029 to Keung et al. teaches a clamp that adapts to walls of slightly differing thicknesses, but still cannot effectively clamp walls of greatly varying thicknesses. An especially thick wall would prevent Keung's clamp from being fully engaged, and an especially thin wall would not be clamped at all.

Thus, there is still a need for a more effective a clamping mechanism that accommodates walls or other partitions of different thicknesses.

### SUMMARY OF THE INVENTION

The present invention provides apparatus, systems and methods in which a clamp uses an optional cap or other extender to adapt to partitions of different thicknesses. Such clamps can be used to attached speakers, doorbells, displays, phones, shelves, light fixtures, and myriad other devices.

As used herein, the term “partition” include any architectural or other partition suitable for supporting a mount, regardless of orientation. Thus, for example, drywall, sheetrock, paneling, plasterboard, tile, wall studs, doors, furniture, cabinetry, and even window glass are all considered partitions. Contemplated partitions do not even need to be flat. The terms front and back sides of a partition refer to the two major opposing sides of the partition, so that the outer and inner sides of an installed wallboard would be considered the front and back sides, respectively, and the bottom and top sides of an installed ceiling tile would be considered the front and back sides, respectively.

Preferred embodiments include at least two members, or movement restrictors, coupled to the device that can be positioned on opposite sides of the partition, and a tightener that advances one member towards the other. Corresponding members can vary in both size and number. In an exemplary embodiment, one member is a rim that extends from a perimeter of the device with a plurality of corresponding “feet” that squeeze the rim against the partition.

The extender is preferably a user detachable cap that attaches to an end of one of the members, adjusting the available travel distance between the member and the partition. The cap can be attached to the member in any suitable manner, including use of “ears”, posts, and so forth. A kit can include extenders of different sizes, preferably adding at least 0.5 to 2 cm to the effective length of any member. Since the extender alters the effective length of the member, the same clamp can be used to attach a device to a partition of less than 1.2 cm, more than 10 cm, and everything in between.

Since a member can interfere with installation of whatever device is being installed, a mechanism can advantageously be included that parks one or more of the members out of the way, for example in a recess. This is preferably done by including a mechanism that moves the member in a motion parallel to a plane of the partition. Suitable mechanisms include hinges, guide rails, channels, tracks, bearings, and screws. Most preferably, the mechanism includes a screw or spring that biases the member away from its parked position.

The tightener can also include a screw or spring that biases the members towards each other.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1a is a vertical cross-section of a clamping device mounted on a thin partition.

FIG. 1b is a vertical cross-section of the device of FIG. 1 mounted on a thick partition.

FIG. 2a is a side view of an exemplary clamping device with an exemplary foot and an alternative cap.

FIG. 2b is the side view of FIG. 2a with the foot “toggled” to a recessed position.

FIG. 3a is a vertical cross-section of the foot of FIG. 2a.

FIG. 3b is a side view of the foot of FIG. 2a.

FIG. 4a is a vertical cross-section of the cap of FIG. 2a.

FIG. 4b is a side view of the cap of FIG. 2a.

### DETAILED DESCRIPTION OF THE DRAWING

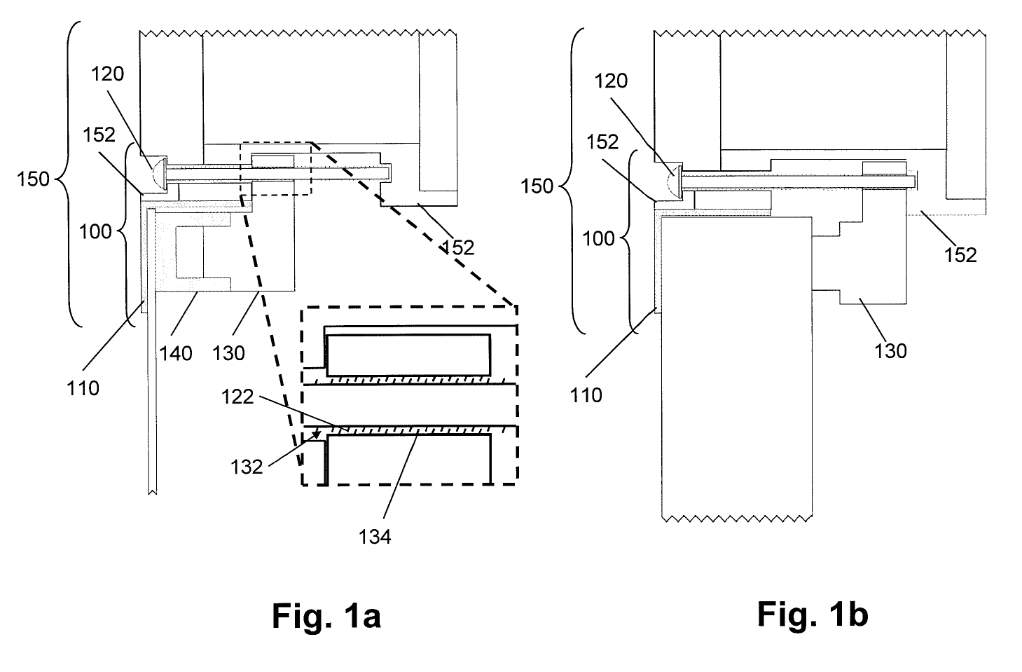

In FIG. 1, a mount 150 generally has a clamping device 100 comprising rim 110, tightener 120, foot 130, and cap 140. In this embodiment, the rim 110 is considered to be an outer movement restrictor, and the combination of the foot 130 and cap 140 is considered to be the inner movement restrictor.

Rim 110 is shaped to extend from a perimeter 152 of mount 150 and abuts a portion of the front of thin partition 160. Although rim 110 can be positioned on a pad (not shown) or other suitable object (not shown) that cushions and/or locks rim 110 to thin partition 160, rim 110 is preferably positioned directly on thin partition 160. Although rim 110 is shown as a ridge attached to a perimeter of mount 150, the rim can be made integrally with the mount and can comprise one or more ridges (not shown) positioned to restrict the movement of the mount with respect to the partition.

Contemplated rims can be made of any suitable material(s), for example plastic, metal, or wood.

Tightener 120 is a screw having threads 122 that mate with threads 134 inside a channel 132 of foot 130. Channel 134 extends down the length of tightener 120, and as tightener 120 turns clockwise, foot 130 is pulled towards rim 110. In this instance, the tightener is a threaded screw, but all suitable alternative tighteners are contemplated, including for example a bolt, wing nut, latch, clip, elastic band, clip strap, or any other conventional fastener that exerts a force on foot 130. Moreover, more than one tightener can be functionally coupled to the foot, and additional tighteners could also be attached to the rim to also pull the rim towards the foot. Indeed, suitable tighteners do not even need to thread through the foot or turn in any particular direction to provide a compressing force.

For durability and cost-effectiveness, the foot is preferably made from hard plastic, although wood, metal, and other materials are also suitable.

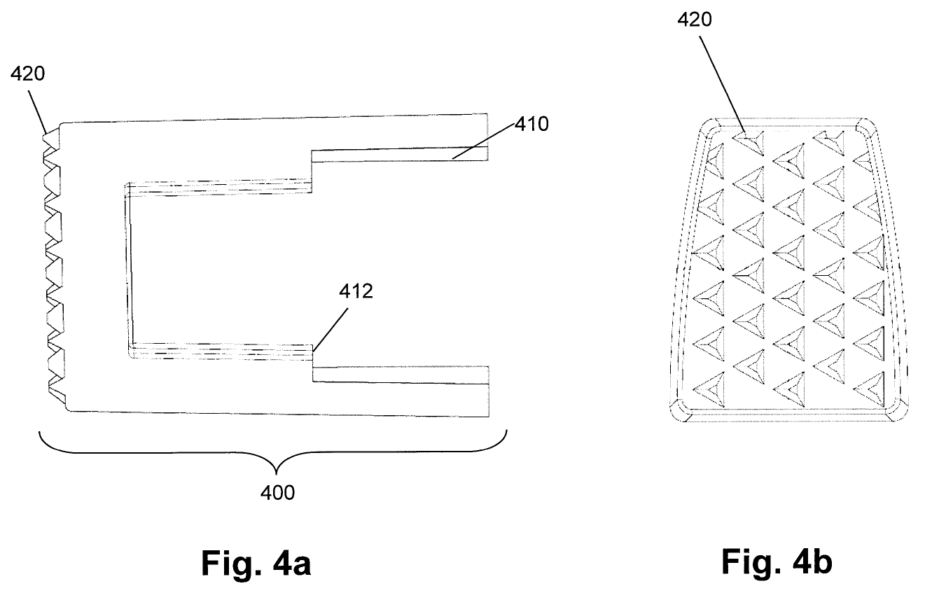

Foot 130 “hinges” on tightener 120 to move foot 130 flush during installation. Preferably, the foot could pivot by at least 80 degrees into a recess (shown in FIG. 4b) within the mount, which enables a user to move the foot completely out of the way during installation and removal of the mount 150. Once the rim is properly positioned on the front of the partition, the foot can be pivoted into a suitable position on the partition opposite the rim.

One end of foot 130 is shaped to receive optional cap 140, which restricts the distance foot 130 can travel. Since foot 130 is not long enough to reach the back side of thin partition 160, cap 140 is used to alter the effective length of the foot. Although pads, spacers, or other suitable materials (not shown) can be disposed between the cap and the partition, it is preferred to abut the cap directly against the partition. The cap and foot preferably have corresponding indents and detents (not shown) that enable the cap to snap into place.

Cap 140 is shaped with “ears” that wrap around a post on foot 130. But a cap could couple to a foot in other contemplated manners, for example by inserting a post within a hole in the foot, or by mating two threaded surfaces. Additionally, multiple caps may be provided to alter the length of the cap by different amounts. Caps could be designed to stack on top of each other, or caps of different lengths could be provided that couple to the same foot. In an exemplary embodiment, the cap can have a telescoping post that couples to a hole within the foot and locks into place at pre-designated lengths. If multiple feet are provided on a single mount, the caps are preferably interchangeable with the different feet to accommodate partitions of varying thicknesses.

Caps generally comprise a single piece and a single material, although multiple pieces and multiple materials can be used. Contemplated materials include plastic, wood, and metal. The cap preferably alters the length of the foot by at least 2 cm, enabling the same mount to couple to a partition (or otherwise span) less than 1.2 cm to more than 5 cm.

In FIG. 1b, the same mount 150 is attached to thick partition 162, except that here the cap 140 has been removed.

It is likely that a given mount would have multiple clamping devices positioned radially around the perimeter. And it is also likely that mounts would be sold with caps of different sizes.

Although the aesthetics would likely be undesirable, positions of the rim and the foot could possibly be switched so that the foot is positioned at the outer surface of the partition, and the rim is positioned at the inner surface of the partition.

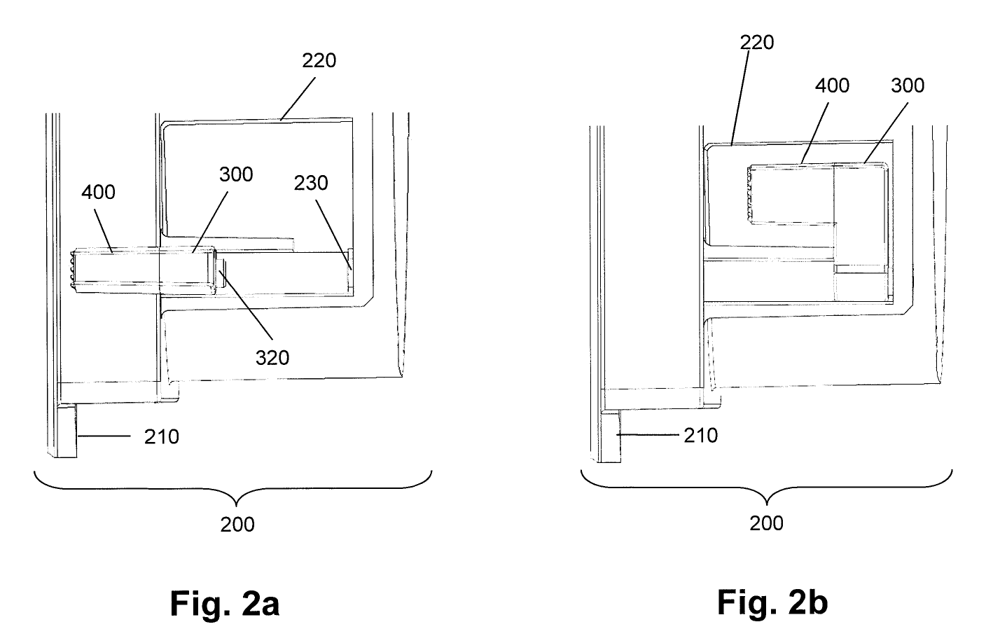

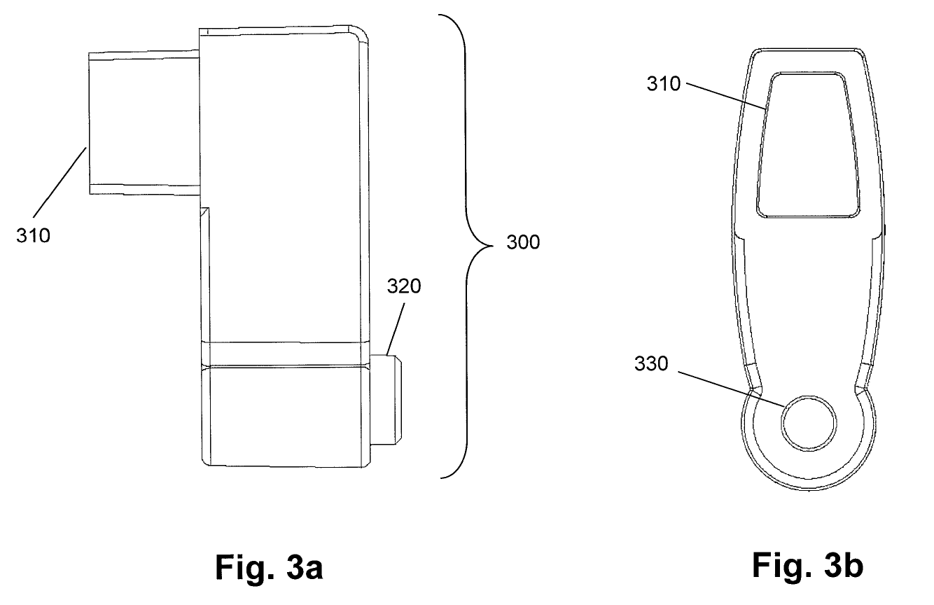

An exemplary mount 200 is presented in FIG. 2a-b with foot 300, cap 400, and lip 210. Detailed views of foot 300 and cap 400 are presented in FIG. 3a-b and FIG. 4a-b, respectively. Pivot channel 320 is shaped to mate with niche 230 in mount 200, and thereby hold the foot in place within the mount. Once foot 300 is installed into the mount, a screw or other tightener (not shown) can be threaded through hole 330 in foot 300. During installation, foot 300 can “toggle” into recess 220, which enables a user to move foot 300 completely out of the way during installation and removal of the mount 200.

When a longer foot is needed, the cap 400 is placed on foot 300, such that the foot end 310 extends into cap recess 410. In this particular embodiment, the foot end 310 extends only part way into the recess 410, stopping at ridge 412. On the lateral surface of cap 400 that would abut the partition (not shown), the cap 400 has ridges 420 that help hold cap 400 in place.

Thus, specific embodiments and applications of partition clamps have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A mounting system that clamps a device to front and back sides of a partition, comprising:
an outer movement restrictor disposed at the front side of the partition;
an inner movement restrictor disposed at the back side of the partition;
a tightener that compresses the partition between the outer and inner movement restrictors; and
a first optional restrictor functionally disposed to limit travel of the inner restrictor.

2. The mounting system of claim 1, wherein the outer movement restrictor comprises a rim.

3. The mounting system of claim 1, further comprising a hinge that couples the inner movement restrictor to the device.

4. The mounting system of claim 2, wherein the hinge is disposed to pivot the inner movement restrictor into a recess of the device.

5. The mounting system of claim 1, wherein the tightener comprises a screw.

6. The mounting system of claim 1, wherein the optional restrictor limits the travel by at least 2 cm.

7. The mounting system of claim 1, further comprising a second optional restrictor functionally disposed to limit the travel of the inner restrictor by an amount different from that provided by the first optional restrictor.

8. The mounting system of claim 1, further comprising a second inner movement restrictor, and a second optional restrictor functionally disposed to limit travel of the second inner movement restrictor.

9. The mounting system of claim 1, wherein the device comprises a speaker.

10. A method of mounting a device to a partition, comprising:
positioning a portion of the device on a first side of the partition;
positioning a foot on a second side of the partition;
manipulating an extender to alter an available travel distance of the foot; and
operating a tightener that draws the foot towards the partition.

11. The method of claim 10, wherein the step of manipulating the extender comprises coupling the extender to the foot.

12. The method of claim 10, wherein the step of manipulating the extender comprises removing the extender from the foot.

13. The method of claim 12, further comprising coupling a different extender to the foot.

14. The method of claim 10, further comprising pivoting the foot at least 80 degrees.

15. The method of claim 10, wherein the step of manipulating comprises altering the available travel distance by at least 2 cm.

16. The method of claim 10, further comprising inserting the device through a hole in the partition having a thickness of less than 1.2 cm.

17. The method of claim 10, further comprising inserting the device through a hole in the partition having a thickness of less than 0.5 cm.

18. A speaker assembly adapted to be attached to a partition, comprising:
first and second members coupled to a speaker, and positionable on opposite sides of the partition;
the first member having a first user detachable cap; and
a tightener that advances the first member towards the second member.

19. The speaker assembly of claim 18, wherein the tightener comprises a screw.

20. The speaker assembly of claim 18, wherein the tightener comprises a spring.

21. The speaker assembly of claim 18, further comprising a second cap having a thickness that differs from the first cap by at least 0.5 cm.

22. The speaker assembly of claim 18, further comprising a mechanism that moves the first member in a motion parallel to a plane of the partition.

23. The speaker assembly of claim 22, wherein the mechanism comprises a hinge.

24. The speaker assembly of claim 22, wherein the mechanism comprises a guiderail.
